(19) United States
(12) Patent Application Publication
(10) Pub. No.: US 2024/0377828 A1
(43) Pub. Date: Nov. 14, 2024

(54) MOBILITY AIDS, MOBILITY AIDS ASSISTIVE SYSTEM AND OPERATING METHOD THEREOF

(71) Applicant: WISTRON CORP., New Taipei City (TW)

(72) Inventors: Chen-Yi LIANG, New Taipei City (TW); Hsin-Wen Kuo, New Taipei City (TW); Cheng Hsing Liu, New Taipei City (TW)

(21) Appl. No.: 18/346,918

(22) Filed: Jul. 5, 2023

(30) Foreign Application Priority Data
May 12, 2023 (TW) 112117614

(51) Int. Cl. G05D 1/02; A61G 5/04; A61G 5/10

(52) U.S. Cl. CPC G05D 1/0223; A61G 5/04; A61G 5/10; A61H 2201/5007

(57) ABSTRACT

An operation method of a mobility aid includes following steps: detecting a distance between the mobility aid and a sensing target by a distance sensor; detecting a three-axis angle of the mobility aid by an inertial measurement unit; loading and executing an artificial intelligence model from a storage device by a processing device to calculate a suggested speed value according to the artificial intelligence model and an input parameter set, wherein the input parameter set comprises the distance and the three-axis angle; and moving the mobility aid by a power output device according to the suggested speed value.

### CROSS-REFERENCE TO RELATED APPLICATIONS

This non-provisional application claims priority under 35 U.S.C. § 119 (a) on Patent Application No(s). 112117614 filed in Taiwan, R.O.C. on May 12, 2023, the entire contents of which are hereby incorporated by reference.

### BACKGROUND

### 1. Technical Field

The present disclosure relates to artificial intelligence and mobility aids, and more particular to mobility aids and mobility aids assistive system that applies artificial intelligence models.

### 2. Related Art

Existing mobility aids only provide support functions. When users move, they need to exert their own force to change the position of the mobility aid. Even for some mobility aids with moving capabilities, they can only provide increased power on specific terrains, such as slopes. The assistance provided by these mobility aids is too standardized, and they cannot provide corresponding assistive power according to the undulations of the terrain. Overall, existing mobility aids are unable to provide suitable services for users with mobility impairments.

### SUMMARY

In light of the above descriptions, the present disclosure proposes a mobility aid and a mobility aid assistive system that can assist users' mobility in various situations.

According to one or more embodiment of the present disclosure, an operation method of a mobility aid comprises: detecting a distance between the mobility aid and a sensing target by a distance sensor; detecting a three-axis angle of the mobility aid by an inertial measurement unit; loading and executing an artificial intelligence model from a storage device by a processing device to calculate a suggested speed value according to the artificial intelligence model and an input parameter set, wherein the input parameter set comprises the distance and the three-axis angle; and moving the mobility aid by a power output device according to the suggested speed value.

According to one or more embodiment of the present disclosure, a mobility aid comprises a body, a distance sensor, an inertial measurement unit, a storage device, a processing device, and a power output device. The distance sensor detects a distance between the body and a sensing target. The inertial measurement unit detects a three-axis angle of the body. The storage device stores an artificial intelligence model. The processing device is electrically connected to the distance sensor, the inertial measurement unit, and the storage device. The processing device executes the artificial intelligence model to calculate a suggested speed value according to an input parameter set, and the input parameter set comprises the distance and the three-axis angle. The power output device is electrically connected to the processing device. The power output device moves the body according to the suggested speed value. The body is configured to accommodate the distance sensor, the inertial measurement unit, the storage device, the processing device, and the power output device.

According to one or more embodiment of the present disclosure, a mobility aid assistive system comprises a mobility aid and a portable device. The mobility aid comprises a body, a distance sensor, an inertial measurement unit, a storage device, a first processing device, a first communication circuit, and a power output device. The distance sensor detects a distance between the body and a sensing target. The inertial measurement unit detects a three-axis angle of the body. The storage device stores an artificial intelligence model. The first processing device is electrically connected to the distance sensor, the inertial measurement unit, and the storage device. The first processing device executes the artificial intelligence model to calculate a suggested speed value according to an input parameter set, and the input parameter set comprises the distance and the three-axis angle. The first communication circuit is disposed on the body and electrically connected to the first processing device. The first communication circuit receives a corrected speed value or a mobility level setting associated with the sensing target, sends a mobility aid status, and the input parameter set further comprises the mobility level setting. The power output device is electrically connected to the first processing device, wherein the power output device moves the body according to the suggested speed value. The body is configured to accommodate the distance sensor, the inertial measurement unit, the storage device, the first processing device, the first communication circuit, and the power output device. The portable device comprises an input circuit, a second communication circuit, a second processing device. The input circuit receives an input signal associated with the corrected speed value or the mobility level setting associated with the sensing target. The second communication circuit is communicably connected to the first communication circuit. The second processing device is electrically connected to the input circuit for receiving the input signal, electrically connected to the second communication circuit and sending the corrected speed value or the mobility level setting according to the input signal.

The aforementioned context of the present disclosure and the detailed description given herein below are used to demonstrate and explain the concept and the spirit of the present application and provides the further explanation of the claim of the present application.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of a mobility aid according to an embodiment of the present disclosure;

FIG. 2 is a schematic diagram of the placement of the inertial measurement unit according to an embodiment of the present disclosure;

FIG. 3 is a schematic diagram of the placement of the first distance sensor, the second distance sensor, and the third distance sensor according to an embodiment of the present disclosure;

FIG. 4 is a block diagram of the mobility aid according to another embodiment of the present disclosure;

FIG. 5 is a block diagram of the mobility aid according to another embodiment of the present disclosure;

FIG. 6 is a flowchart of an operating method of a mobility aid according to an embodiment of the present disclosure;

FIG. 7 is a flowchart of an operating method of a mobility aid according to another embodiment of the present disclosure;

FIG. 8 is a block diagram of the mobility aid assistive system according to an embodiment of the present disclosure; and

FIG. 9 is a flowchart of an operating method of the mobility aid assistive system according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

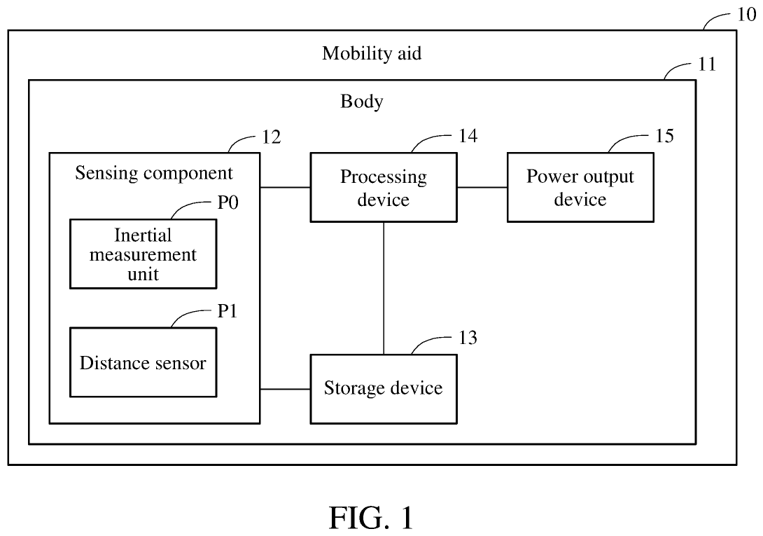

FIG. 1 is a block diagram of a mobility aid 10 according to an embodiment of the present disclosure. As shown in FIG. 1, the mobility aid 10 includes a body 11, a sensing component 12, a storage device 13, a processing device 14, and a power output device 15. The body 11 is configured to accommodate the sensing component 12, the storage device 13, the processing device 14, and the power output device 15.

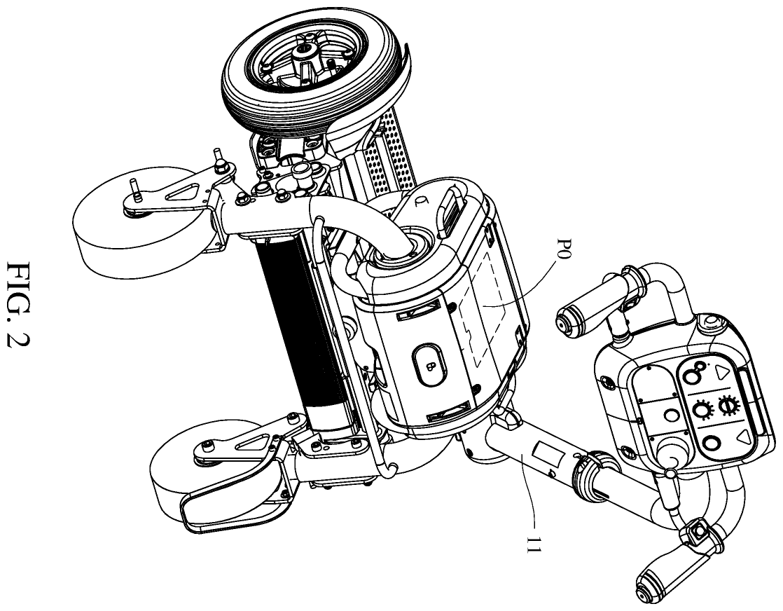

The body 11 is a structure that provides support and maintains balance during user walking, such as a shell with handles, support structures, and storage space, and is equipped with movable wheels. In an embodiment, the sensing component 12 includes an inertial measurement unit (IMU) P0 and a distance sensor P1. The IMU P0 is configured to detect a three-axis angle of the body 11, thus providing information about the terrain on which the mobility aid 10 is situated, such as the current slope information. FIG. 2 is a schematic diagram of the placement of the IMU P0 according to an embodiment of the present disclosure. As shown in FIG. 2, the IMU P0 is disposed on the center of the body 11. In another embodiment, an accelerometer and a gyroscope can be used to achieve the functions of the IMU P0.

The distance sensor P1 is configured to detect a distance between the body 11 and a sensing target, such as the user of the mobility aid 10. In an example, the distance sensor P1 may adopt an infrared sensor. The present disclosure does not limit the number of distance sensors P1. In practice, increasing the number of distance sensors P1 allows for a more complete understanding of the position relationship between the sensing target and the mobility aid 10. For example, adopting more than two distance sensors can assist in evaluating the turning operation of the mobility aid 10, and adopting more than three distance sensors allows for fault tolerance, where one of the distance sensors may be disturbed by noise (such as sunlight), but there are still two other distance sensors available for use.

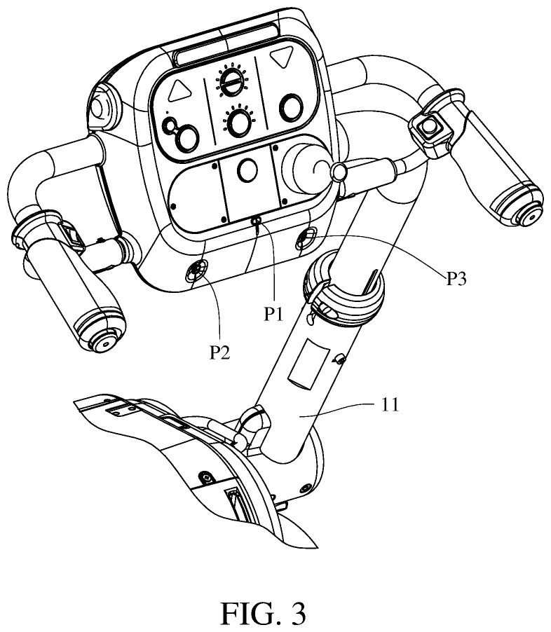

In an embodiment, there are three distance sensors, namely the first distance sensor, the second distance sensor, and the third distance sensor. FIG. 3 is a schematic diagram showing the position of the first distance sensor, the second distance sensor, and the third distance sensor according to an embodiment of the present disclosure. As shown in FIG. 3, the second distance sensor P2 and the third distance sensor P3 are respectively disposed on the body 11, on opposite sides of the first distance sensor P1. The first distance sensor P1 is configured to detect a first distance between the body 11 and the sensing target. The second distance sensor P2 is configured to detect a second distance between the body 11 and the sensing target. The third distance sensor P3 is configured to detect a third distance between the body 11 and the sensing target. The first distance sensor P1, the second distance sensor P2, and the third distance sensor P3 are all electrically connected to the processing device 14 to transmit the sensed distances.

The storage device 13 is configured to store an artificial intelligence (AI) model. In an embodiment, the storage device 13 may be any of the following examples: flash memory, hard disk drive (HDD), solid-state drive (SSD), dynamic random-access memory (DRAM), static random-access memory (SRAM), or other non-volatile memory. However, the present disclosure is not limited to these examples.

The processing device 14 is electrically connected to the sensing component 12 and the storage device 13. The processing device 14 is configured to execute the AI model to calculate a suggested speed value according to the input parameter set provided by the sensing component 12. In an embodiment, the processing device 14 can be any of the following examples: central processing unit (CPU), microcontroller (MCU), application processor (AP), field-programmable gate array (FPGA), application-specific integrated circuit (ASIC), digital signal processor (DSP), system-on-a-chip (SOC), deep learning accelerator. However, the present disclosure is not limited to these examples.

The content of the input parameter set varies depending on the configuration of the sensing component 12. For example, when the sensing component 12 includes a distance sensor P1 and an IMU P0, the input parameter set includes a distance and a three-axis angle. When the sensing component 12 includes three distance sensors P1, P2, and P3 and an IMU P0, the input parameter set includes a first distance, a second distance, a third distance, and a three-axis angle.

The power output device 15 is electrically connected to the processing device 14. The power output device 15 generates a power source according to the suggested speed value to move the body 11 of the mobility aid 10 according to power source. In an embodiment, the power output device 15 includes a motor controller, a motor, and wheels. The motor controller calculates the motor's rotation speed according to the suggested speed value and drives the wheels using the motor to move the mobility aid 10.

Two additional embodiments of the sensing component 12 are described as follows: In an embodiment, in addition to the distance sensor P1 and the IMU P0, the sensing component 12 further includes a temperature sensor, a timer, and a speed detector. The temperature sensor is disposed on the body 11 and electrically connected to the processing device 14. The temperature sensor is configured to obtain an air temperature. The timer is disposed on the body 11 and electrically connected to the processing device 14. The timer is configured to accumulate an operating duration of the mobility aid 10. Although the speed detector belongs to the sensing component, its optimal placement is in close proximity to the power output device 15 to obtain the speed of the power source (such as the actual rotation speed of a motor). In an embodiment, a Hall sensor may be used as the speed detector. Therefore, the input parameter set further includes air temperature and an operating duration. In other embodiments, the current speed may be used as training data.

In an embodiment, in addition to the distance sensor P1 and the IMU P0, the sensing component 12 further includes an input device. The input device is disposed on the body 11 and electrically connected to the processing device 14. The input device is configured to receive a mobility level setting associated with the sensing target. Therefore, the input parameter set further includes the mobility level setting. The input device is, for example, a button, a dial switch, a touch screen, or any electronic component configured to input numbers or codes, and the present disclosure does not limit thereof. The mobility level setting refers to the classification criteria of the Gross Motor Function Classification System. Level 1 indicates the ability to run and jump on a flat surface. Level 2 indicates the ability to walk on a flat surface but with difficulty walking on uneven surfaces. Level 3 indicates the need to hold onto stable objects or someone else for walking. Level 4 indicates the inability to walk independently but can maintain a sitting position on a chair with armrests. Level 5 indicates the inability to maintain a sitting position on a chair with armrests and tends to slump. Therefore, users can input the value of level setting by the input device, allowing the AI model to output appropriate suggested speed values according to the user's mobility level.

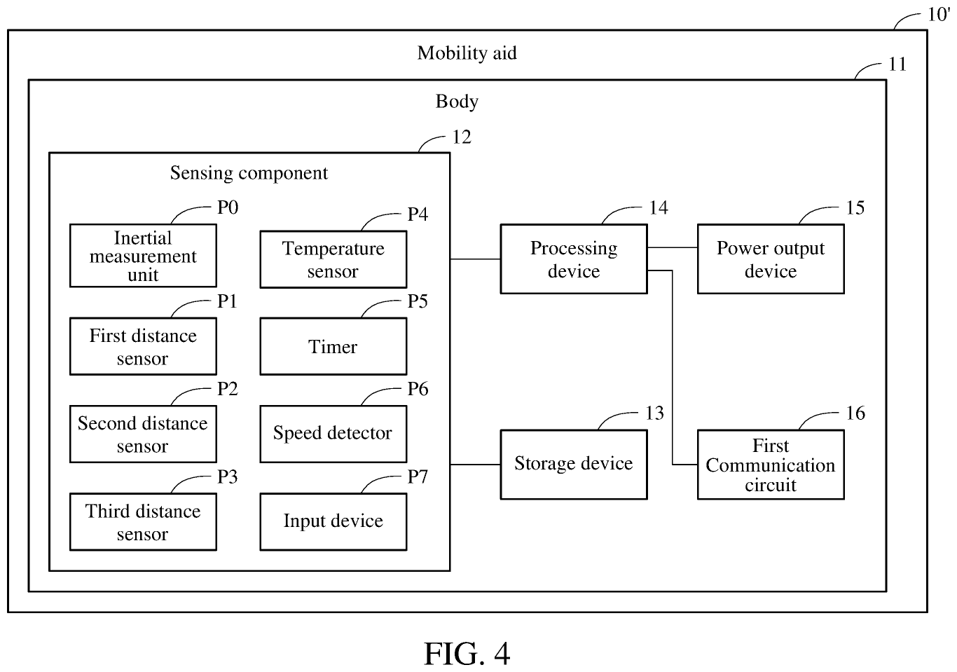

The above describes two embodiments of the sensor component 12. FIG. 4 is a block diagram of the mobility aid incorporating the above embodiments. As shown in FIG. 4, the sensor component 12 includes multiple sensing elements: an IMU P0, a first distance sensor P1, a second distance sensor P2, a third distance sensor P3, a temperature sensor P4, a timer P5, a speed detector P6, and an input device P7. These sensing elements P0-P7 shown in FIG. 4 may be selectively installed according to the practical requirement, and the present disclosure is not limited to the types and quantities of components in the sensor component 12 as described above.

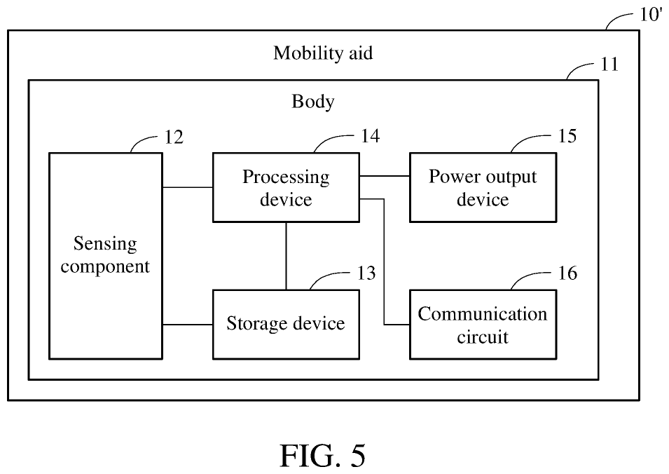

FIG. 5 is a block diagram of the mobility aid according to another embodiment of the present disclosure. In this embodiment, the mobility aid 10′ may further include a communication circuit 16. The communication circuit 16 is disposed on the body 11 and electrically connected to the processing device 14. The communication circuit 16 is configured to receive a speed value or a corrected speed value. After receiving the corrected speed value, the processing device 14 uses it as the suggested speed value and sends it to the power output device 15. In an embodiment, the communication circuit 16 may adopt one of the following communication standards: Bluetooth, Wi-Fi, ZigBee, and mobile networks. However, the present disclosure is not limited to these examples. In another embodiment, the processing device 14 receives the mobility level setting value by the communication circuit 16.

The training process of the AI model may include the following seven stages.

Stage 1: Data collection. In a usage scenario composed of various terrains, temperatures, and operating durations, the user operates the mobility aid 10′ and the speed setting of the mobility aid 10′ is adjusted either by the user or a caregiver, and thus selecting an appropriate speed setting. During this period, the processing device 14 records the speed setting and sensor data obtained by the sensor component 12 into the storage device 13.

Stage 2: Data preparation. After collecting a large amount of data, relevant features are selected for analysis, such as terrain reflected by the three-axis angle measured by the IMU P0, operating duration of continuous usage, distance between the user and the mobility aid 10, and the user's mobility level setting. The following table provides an example of a single training data entry:

TABLE 1

| | |
|---|---|
| Terrain (slope) | 3.2 degrees, 4 degrees, 3.5 degrees, |
| | 3.6 degrees, 4.2 degrees |
| Operating Duration | 18 minutes |
| User distance | 25 cm, 22 cm, 24 cm |
| Mobility level setting | Level 2 |
| Speed of the mobility aid | 45 revolutions per minute (rpm) |

In an embodiment, the training data of terrain comes from the three-axis angle rotating around the transverse axis of the IMU P0. The average of the five most recent data points is taken, and when a new data point is received, the oldest data point in the original five data points is replaced with the new one, and the average of these five data points is calculated. These angle data reflect the slope of the terrain. In an embodiment, the user distance is the average of the values measured by the three distance sensors P1, P2, and P3 at the same moment. Whenever the three distance sensors P1, P2, and P3 generate new data, the average of the three distance measurements is calculated. In an embodiment, the mobility level setting can be divided into three levels: level 1, capable of running and jumping on a flat surface; level 2, experiencing difficulty on slopes; and level 3, requiring assistance tools for walking. In an embodiment, the speed of the mobility aid refers to the average revolutions per minute during the use of the mobility aid 10.

Stage 3: Model selection. In an embodiment, the AI model may be one of the following examples: Artificial Neural Network (ANN) or Recurrent Neural Network (RNN). However, the present disclosure is not limited to these examples.

Stage 4: Model training. The model is trained using K-fold cross-validation, where each data point takes turns being the validation data while the remaining data points are used as training data. The input data includes the user's mobility level, slope (terrain), operating duration of continuous use, and the distance between the mobility aid 10 and the user measured by the distance sensors. The output data is the speed value.

In an embodiment, before the AI model's training, normalization of the training data may be performed to avoid issues arising from varying ranges of input or output data. Assuming x represent the original data and y represent the normalized data. One method for normalization is as follows:

$$y = ( {y}_{max} - {y}_{min} ) * \frac{x - {x}_{min}}{{x}_{max} - {x}_{min}} + {y}_{min} \qquad ( Equation 1 )$$

where yₘₐₓ represents the maximum value of the result, and yₘᵢₙ represents the minimum value of the result. All data is set between 0 and 1, so yₘₐₓ=1 and yₘᵢₙ=0. Several examples of actual values are as follows:
Example 1, Terrain (degrees): xₘₐₓ=7, xₘᵢₙ=−7. Assuming the current terrain is 3 degrees, applying the formula yields y=0.714.
Example 2, Operating duration of continuous use (minutes): xₘₐₓ=180, xₘᵢₙ=0. Assuming the current operating duration is 45 minutes, applying the formula yields y=0.25.
Example 3, Distance between the user and the machine (centimeters): xₘₐₓ=80, xₘᵢₙ=0. Assuming the currently measured value is 24 cm, applying the formula yields y=0.3.
Example 4, User's mobility level: Divided into three levels-able to run and jump on a flat surface with y=1, struggles on inclines with y=0.67, and requires assistance tools for walking with y=0.33.

Stage 5: Calculate the error between the predicted values and the actual values of the AI model. In an embodiment, the Mean Absolute Error (MAE) is adopted.

Stage 6: Parameter adjustment. According to the calculation results from Stage 5, the hyperparameters of the AI model may be adjusted to achieve better prediction results. In an embodiment, the hyperparameters include adjusting the activation function, the number of hidden layers, and the number of neurons. In an embodiment, Bayesian Optimization is adopted to find the optimal hyperparameters, while in other embodiments, the hyperparameters are adjusted in conjunction with backpropagation to find better prediction results. In other embodiments, Stage 4, Stage 5, and Stage 6 are repeated until the average absolute error is below a threshold, such as a threshold of 0.5.

Stage 7: Prediction and inference. The trained AI model is applied in practical operations to provide the user with appropriate speeds according to different situations. The processing device 14 inputs the received data (input parameters) into the trained AI model. The AI model calculates and updates the speed value according to each input data.

The following are examples of multiple datasets used for training the AI model.

### Example 1

| | |
|---|---|
| Terrain (slope) | 0.2 degrees, 0.4 degrees, 0.5 degrees, |
| | 0 degrees, 0.2 degrees |
| Operating Duration | 18 minutes |
| User distance | 25 cm, 22 cm, 24 cm |
| Mobility level setting | level 1/ level 2/ level 3 |
| Temperature | 24° C. |
| Speed of the mobility aid | 55 rpm/45 rpm/35 rpm |

Example 2, when the machine enters a slope, the user's walking becomes more difficult, and the output speed value will be slower.

| | |
|---|---|
| Terrain (slope) | 3.2 degrees, 4 degrees, 3.5 degrees, |
| | 3.6 degrees, 4.2 degrees |
| Operating Duration | 18 minutes |
| User distance | 25 cm, 22 cm, 24 cm |
| Mobility level setting | level 2 |
| Temperature | 24° C. |
| Speed of the mobility aid | 35 rpm |

Example 3, as the operating duration of continuous use increases, the user's physical strength is depleted more, resulting in a slower output speed value.

| | |
|---|---|
| Terrain (slope) | 0.2 degrees, 0.4 degrees, 0.5 degrees, |
| | 0 degrees, 0.2 degrees |
| Operating Duration | 28 minutes |
| User distance | 25 cm, 22 cm, 24 cm |
| Mobility level setting | level 2 |
| Temperature | 24° C. |
| Speed of the mobility aid | 35 rpm |

Example 4, as the distance between the machine and the user increases, it indicates that the speed may be too fast, resulting in a slower output speed value.

| | |
|---|---|
| Terrain (slope) | 0.2 degrees, 0.4 degrees, 0.5 degrees, |
| | 0 degrees, 0.2 degrees |
| Operating Duration | 28 minutes |
| User distance | 52 cm, 55 cm, 54 cm |
| Mobility level setting | level 2 |
| Temperature | 24° C. |
| Speed of the mobility aid | 35 rpm |

Example 5, when personnel enter a slope after prolonged use, it means they are entering a more challenging uphill section after exerting physical effort, resulting in a slower output speed value.

| | |
|---|---|
| Terrain (slope) | 3.2 degrees, 4 degrees, 3.5 degrees, |
| | 3.6 degrees, 4.2 degrees |
| Operating Duration | 28 minutes |
| User distance | 25 cm, 22 cm, 24 cm |
| Mobility level setting | level 2 |
| Temperature | 24° C. |
| Speed of the mobility aid | 30 rpm |

Example 6, when the temperature is higher than room temperature, it indicates that the user's physical condition is poorer, resulting in a slower output speed value.

| | |
|---|---|
| Terrain (slope) | 3.2 degrees, 4 degrees, 3.5 degrees, |
| | 3.6 degrees, 4.2 degrees |
| Operating Duration | 28 minutes |
| User distance | 25 cm, 22 cm, 24 cm |
| Mobility level setting | level 2 |
| Temperature | 32° C. |
| Speed of the mobility aid | 35 rpm |

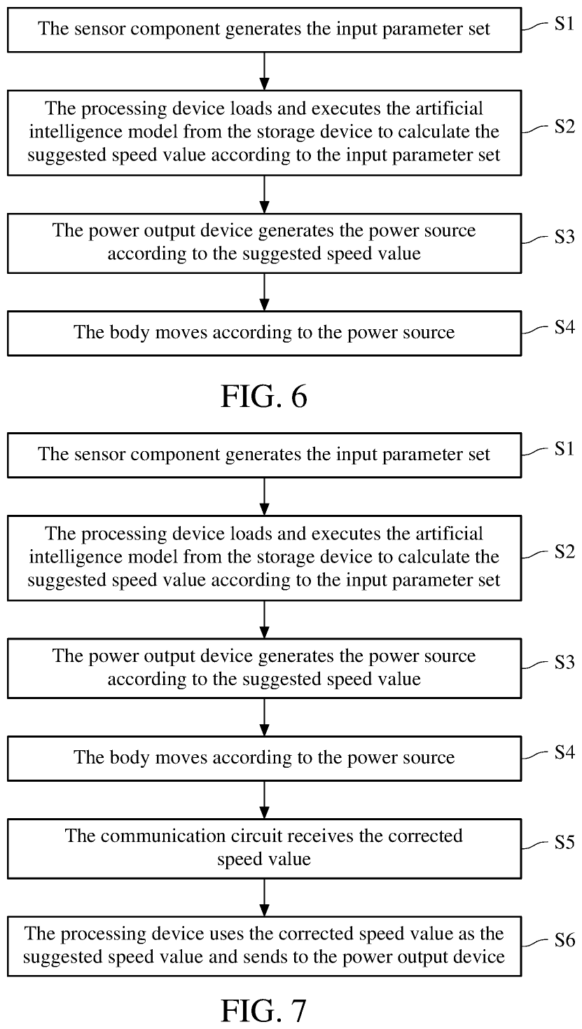

FIG. 6 is a flowchart of the operating method of a mobility aid according to an embodiment of the present disclosure. This method is applicable to the mobility aid 10 shown in FIG. 1 and the mobility aid 10′ shown in FIG. 4.

Step S1: The sensor components generate an input parameter set. Step S1 includes one or more of the following operations: the IMU P0 detects the three-axis angle of the body 11; the first distance sensor P1 detects the distance between the body 11 and the sensing target; the second distance sensor P2 detects the second distance between the body 11 and the sensing target; the third distance sensor P3 detects the third distance between the body 11 and the sensing target; the temperature sensor obtains the air temperature; the timer calculates the operating duration of the mobility aid 10; and the input device receives the mobility level setting associated with the sensing target. In an embodiment, the processor 14 periodically retrieves the input parameter set from the sensor components 12. The present disclosure does not limit the sampling frequency of each parameter in the input parameter set. For example, the distance sensor P0 can generate a distance measurement value every 3 seconds, and the IMU P0 can generate three-axis angle every 1 second. Please note that the above values are for illustration purposes and not intended to limit the present disclosure.

Step S2: The processing device 14 loads and executes an AI model from the storage device 13 to calculate the suggested speed value according to the input parameter set.

Step S3: The power output device 15 generates power according to the suggested speed value.

Step S4: The body 11 moves according to the power source.

FIG. 7 shows a flowchart of the operating method of a mobility aid according to another embodiment of the present disclosure. This method is applicable to the mobility aid 10′ shown in FIG. 5. In comparison to FIG. 6, the process shown in FIG. 7 includes additional steps S5 and S6. In step S5, the communication circuit 16 receives the corrected speed value. In step S6, after receiving the corrected speed value, the processing device uses this corrected speed value as the suggested speed value and sent to the power output device.

One scenario applicable to FIG. 7 is as follows: when the user operates the mobility aid 10′, if the speed of the mobility aid 10′ is too fast, the caregiver can lower the speed. If the speed of the mobility aid 10′ is too slow, the caregiver can increase the speed. If the mobility aid 10′ is about to collide with an obstacle, the caregiver can control the mobility aid 10′ to stop or rotate to avoid the obstacle.

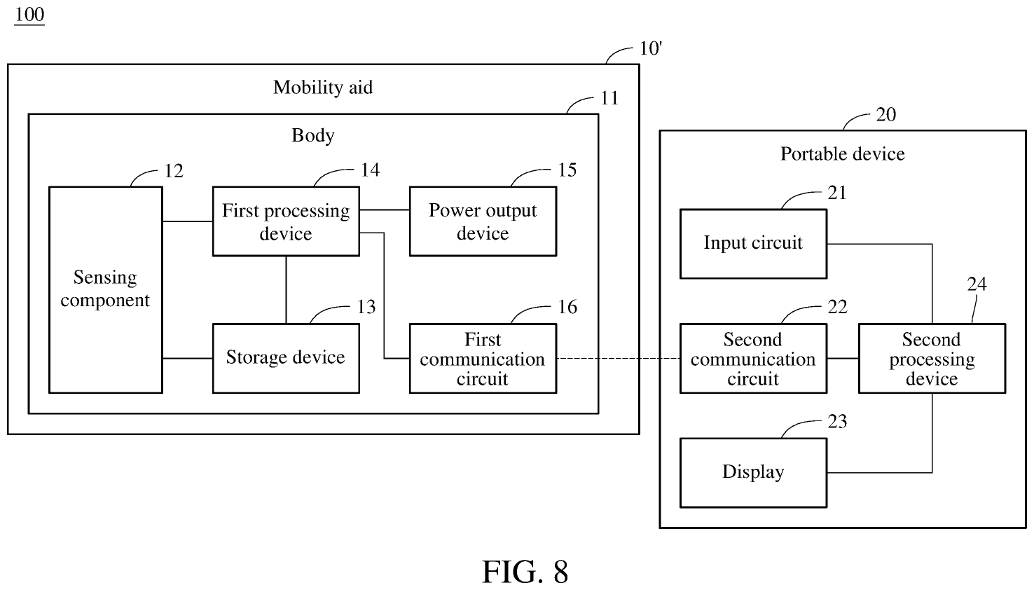

In the aforementioned scenario, the caregiver may control the mobility aid 10′ by a portable device in an assistive system. FIG. 8 shows a block diagram of the mobility aid assistive system according to an embodiment of the present disclosure. As shown in FIG. 8, this system 100 includes the mobility aid 10′ from FIG. 5. Please note that in this case, the processing device and the communication circuit in the mobility aid 10′ are respectively referred to as the first processing device 14 and the first communication circuit 16. The portable device 20 includes an input circuit 21, a second communication circuit 22, a display 23, and a second processing device 24. In an embodiment, the portable device 20 may adopt any of the following examples: a smartphone, a tablet, a laptop, or any electronic device suitable for handheld use by the caregiver.

The first communication circuit 16 in the mobility aid 10′ is configured to send the mobility aid's status. The mobility aid's status may include the current suggested speed value, current air temperature, mobility level setting of the sensing target, etc. The present disclosure does not limit thereof.

The input circuit 21 is configured to receive input signals associated with the corrected speed value. The implementation of the input circuit 21 can refer to the implementation method of the input device in the mobility aid 10 mentioned above.

The second communication circuit 22 is communicably connected to the first communication circuit 16. In an embodiment, the second communication circuit 22 is configured to receive the mobility aid's status and send the corrected speed value. In another embodiment, the second communication circuit 22 is used to send a stop command. In other embodiments, the input circuit 21 is configured to receive mobility level setting, the second communication circuit 22 sends the mobility level setting, the first processing device 14 receives the mobility level setting associated with the sensing target by the first communication circuit 16, and the first processing device 14 adds the latest acquired mobility level setting to the input parameter set.

The display 23 is configured to present pictures associated with the mobility aid's status.

The second processing device 24 is electrically connected to the input circuit 21 to receive input signals, is electrically connected to the second communication circuit 22 to obtain the mobility aid's status, controls the second communication circuit 22 to send the corrected speed value or the mobility level setting according to the input signals, and is electrically connected to the display 23 to control the pictures shown on the display 23.

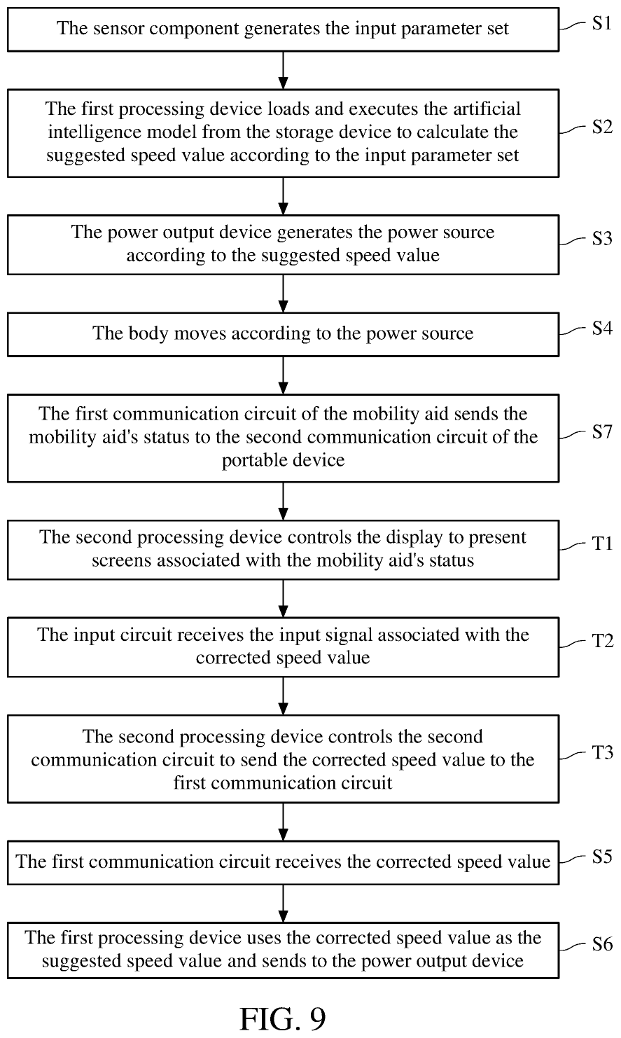

FIG. 9 shows a flowchart of an operating method of the mobility aid assistive system according to an embodiment of the present disclosure. This method is applicable to the mobility aid assistive system 100 shown in FIG. 8. In the process shown in FIG. 9, steps S1 to S4 are basically the same as the operating method of the mobility aid according to an embodiment of the present disclosure shown in FIG. 6.

Step S7: The first communication circuit 16 of the mobility aid 10′ sends the mobility aid's status to the second communication circuit 22 of the portable device 20.

Step T1: After obtaining the mobility aid's status by the second communication circuit 22, the second processing device 24 controls the display 23 to present pictures associated with the mobility aid's status. Step T2: The input circuit 21 receives the input signal associated with the corrected speed value. The input signal is inputted by the caregiver through the input circuit 21. Step T3: The second processing device 24 controls the second communication circuit 22 to send the corrected speed value to the first communication circuit 16 of the mobility aid 10′ according to the input signal.

Step S5: The first communication circuit 16 receives the corrected speed value. Step S6: The first processing device 14 uses the corrected speed value as the suggested speed value and sends it to the power output device 15. By the above process and the assistive system 100 of an embodiment of the present disclosure, the effect of manually adjusting the speed of the mobility aid 10′ by the caregiver is achieved.

In view of the above, the present disclosure provides a mobility aid, a mobility aid assistive system, and a method of operating both. By combining the sensor components and software, the mobility aid can adapt to various terrains and environmental conditions, providing the user with the most suitable assistive power for mobility. The present disclosure applies AI models to learn displacement strategies. By inputting a set of input parameters such as the user's mobility level, the operating duration of mobility aid usage, the current slope, temperature, and the distance between the user and the mobility aid into a pre-trained AI model, the model can infer the appropriate driving speed for the mobility aid.

Although embodiments of the present application are disclosed as described above, they are not intended to limit the present application, and a person having ordinary skill in the art, without departing from the spirit and scope of the present application, can make some changes in the shape, structure, feature and spirit described in the scope of the present application. Therefore, the scope of the present application shall be determined by the scope of the claims.

What is claimed is:

1. An operation method of a mobility aid comprising:
detecting a distance between the mobility aid and a sensing target by a distance sensor;
detecting a three-axis angle of the mobility aid by an inertial measurement unit;
loading and executing an artificial intelligence model from a storage device by a processing device to calculate a suggested speed value according to the artificial intelligence model and an input parameter set, wherein the input parameter set comprises the distance and the three-axis angle; and
moving the mobility aid by a power output device according to the suggested speed value.

2. The operation method of the mobility aid of claim 1, wherein the distance sensor is a first distance sensor, the distance is a first distance, the mobility aid further comprises a second distance sensor and a third distance sensor, and the method further comprises:
detecting a second distance between the mobility aid and the sensing target by the second distance sensor; and
detecting a third distance between the mobility aid and the sensing target by the third distance sensor;
wherein the input parameter set further comprises the second distance and the third distance.

3. The operation method of the mobility aid of claim 1, wherein the mobility aid further comprises a temperature sensor and a timer, and the method further comprises:
obtaining an air temperature by the temperature sensor; and
accumulating an operating duration of the mobility aid by the timer; wherein
the input parameter set further comprises the air temperature and the operating duration.

4. The operating method of the mobility aid of claim 1, wherein the mobility aid further comprises an input device, and the method further comprises:
receiving a mobility level setting associated with the sensing target by the input device;
wherein the input parameter set further comprises the mobility level setting.

5. The operating method of the mobility aid of claim 4, wherein the mobility aid further comprises a communication circuit, and the method further comprises:
in response to receiving a corrected speed value by the processing device through the communication circuit, using the corrected speed value as the suggested speed value and sending the suggested speed value to the power output device;
in response to receiving the mobility level setting associated with the sensing target by the processing device through the communication circuit, adding the mobility level setting to the input parameter set by the processing device; and
in response to receiving a stop command by the processing device through the communication circuit, setting the suggested speed value to zero and sending the suggested speed value to the power output device by the processing device.

6. The operating method of the mobility aid of claim 5, further comprising:
sending a mobility aid status to a portable device by the communication circuit;
in response to receiving the mobility aid status, displaying the mobility aid status on the portable device;
receiving an input signal associated with the corrected speed value or the mobility level setting associated with the sensing target by the portable device; and
sending the corrected speed value or the mobility level setting associated with the sensing target to the mobility aid according to the input signal by the portable device.

7. The operating method of the mobility aid of claim 6, further comprising:
receiving a stop command by the portable device through an input circuit; and
sending the stop command to the mobility aid by the portable device.

8. The operating method of the mobility aid of claim 1, wherein the three-axis angle represents a slope of a terrain on which the mobility aid is situated.

9. The operating method of the mobility aid of claim 1, further comprising, before loading and executing the artificial intelligence model from the storage device by the processing device:
obtaining a plurality of training data, wherein each of the plurality of training data comprises: a slope of a terrain on which the mobility aid is situated, an operating duration of the mobility aid, an actual distance between the mobility aid and the sensing target, a mobility level setting associated with the sensing target, an actual temperature of an environment in which the mobility aid is situated, and an actual speed of the power output device; and
training the artificial intelligence model according to the plurality of training data.

10. The operating method of the mobility aid of claim 1, wherein the three-axis angle comprises an average value of a plurality of angle data measured by the inertial measurement unit.

11. A mobility aid comprising:
a body;
a distance sensor detecting a distance between the body and a sensing target;
an inertial measurement unit detecting a three-axis angle of the body;
a storage device storing an artificial intelligence model;
a processing device electrically connected to the distance sensor, the inertial measurement unit, and the storage device, wherein the processing device executes the artificial intelligence model to calculate a suggested speed value according to an input parameter set, and the input parameter set comprises the distance and the three-axis angle; and
a power output device electrically connected to the processing device, wherein the power output device moves the body according to the suggested speed value;
wherein the body accommodated the distance sensor, the inertial measurement unit, the storage device, the processing device, and the power output device.

12. The mobility aid of claim 11, wherein the distance sensor is a first distance sensor, the distance is a first distance, and the mobility aid further comprises:
a second distance sensor and a third distance sensor disposed on the body, on opposite sides of the first distance sensor, and electrically connected to the processing device; wherein the second distance sensor detects a second distance between the body and the sensing target, the third distance sensor detects a third distance between the body and the sensing target, and the input parameter set further comprises the second distance and the third distance.

13. The mobility aid of claim 11, furthering comprising:
a temperature sensor disposed on the body and electrically connected to the processing device, wherein the temperature sensor obtains an air temperature;
a timer disposed on the body and electrically connected to the processing device, wherein the timer accumulates an operating duration of the mobility aid; and
the input parameter set further comprises the air temperature and the operating duration.

14. The mobility aid of claim 11, furthering comprising:
an input device disposed on the body and electrically connected to the processing device, wherein the input device receives a mobility level setting associated with the sensing target, and the input parameter set further comprises the mobility level setting.

15. The mobility aid of claim 11, furthering comprising:
a communication circuit disposed on the body and electrically connected to the processing device, wherein the communication circuit receives a corrected speed value or a mobility level setting associated with the sensing target, and the input parameter set further comprises the mobility level setting; wherein
after receiving the corrected speed value, the processing device uses the corrected speed value as the suggested speed value and sends the suggested speed value to the power output device.

16. A mobility aid assistive system comprising:
a mobility aid comprising:
a body;
a distance sensor detecting a distance between the body and a sensing target;
an inertial measurement unit detecting a three-axis angle of the body;
a storage device storing an artificial intelligence model;
a first processing device electrically connected to the distance sensor, the inertial measurement unit, and the storage device, wherein the first processing device executes the artificial intelligence model to calculate a suggested speed value according to an input parameter set, and the input parameter set comprises the distance and the three-axis angle;
a first communication circuit disposed on the body and electrically connected to the first processing device, wherein the first communication circuit receives a corrected speed value or a mobility level setting associated with the sensing target, sends a mobility aid status, and the input parameter set further comprises the mobility level setting;
a power output device electrically connected to the first processing device, wherein the power output device moves the body according to the suggested speed value,
wherein the body accommodated the distance sensor, the inertial measurement unit, the storage device, the first processing device, the first communication circuit, and the power output device; and
a portable device comprising:
an input circuit receiving an input signal associated with the corrected speed value or the mobility level setting associated with the sensing target,
a second communication circuit communicably connected to the first communication circuit;
a second processing device electrically connected to the input circuit for receiving the input signal, electrically connected to the second communication circuit and sending the corrected speed value or the mobility level setting according to the input signal.

17. The mobility aid assistive system of claim 16, wherein the distance sensor is a first distance sensor, the distance is a first distance, and the mobility aid further comprises:
a second distance sensor and a third distance sensor disposed on the body, on opposite sides of the first distance sensor, and electrically connected to the first processing device; wherein
the second distance sensor detects a second distance between the body and the sensing target,
the third distance sensor detects a third distance between the body and the sensing target, and
the input parameter set further comprises the second distance and the third distance.

18. The mobility aid assistive system of claim 16, wherein the mobility aid further comprises:
a temperature sensor disposed on the body and electrically connected to the first processing device, wherein the temperature sensor obtains an air temperature;
a timer disposed on the body and electrically connected to the first processing device, wherein the timer accumulates an operating duration of the mobility aid; and
the input parameter set further comprises the air temperature and the operating duration.

19. The mobility aid assistive system of claim 16, wherein the mobility aid further comprises:
an input device disposed on the body and electrically connected to the first processing device, wherein the input device receives a mobility level setting associated with the sensing target, and the input parameter set further comprises the mobility level setting.

20. The mobility aid assistive system of claim 16, wherein:
the input circuit further receives a stop command;
the second processing further controls the second communication circuit to send the stop command to the first communication circuit; and
the first processing device sets the suggested speed value to zero after receiving the stop command through the first communication circuit.
